(19) United States
(12) Patent Application Publication
(10) Pub. No.: US 2023/0196568 A1
(43) Pub. Date: Jun. 22, 2023

(54) ANGIOGRAPHY IMAGE DETERMINATION METHOD AND ANGIOGRAPHY IMAGE DETERMINATION DEVICE

(71) Applicants: Chieh-Hung Chang, Taipei City (TW); Yuan-Hsing Hsu, Taipei City (TW); Jen-Sheng Huang, Taipei City (TW); Nien-Lun Chen, Taipei City (TW); Shih-Hsu Huang, Taipei City (TW); Kun-Sung Chen, Taipei City (TW); Chun-Te Shen, Taipei City (TW); Wei-Ting Chang, Taipei City (TW); Kuo-Ting Tang, Taipei City (TW); Zhih-Cherng Chen, Taipei City (TW)

(72) Inventors: Chieh-Hung Chang, Taipei City (TW); Yuan-Hsing Hsu, Taipei City (TW); Jen-Sheng Huang, Taipei City (TW); Nien-Lun Chen, Taipei City (TW); Shih-Hsu Huang, Taipei City (TW); Kun-Sung Chen, Taipei City (TW); Chun-Te Shen, Taipei City (TW); Wei-Ting Chang, Taipei City (TW); Kuo-Ting Tang, Taipei City (TW); Zhih-Cherng Chen, Taipei City (TW)

(73) Assignee: COMPAL ELECTRONICS, INC., Taipei City (TW)

(21) Appl. No.: 18/081,694

(22) Filed: Dec. 15, 2022

Related U.S. Application Data
(60) Provisional application No. 63/291,461, filed on Dec. 20, 2021.

(51) Int. Cl. G06T 7/00; G06T 5/00; G06T 5/30; G06T 7/62; G06V 10/28; G06V 10/75

(52) U.S. Cl. CPC G06T 7/0012; G06T 5/007; G06T 5/30; G06T 7/62; G06V 10/28; G06V 10/758; G06T 2207/30012; G06V 2201/07

(57) ABSTRACT

Embodiments of the disclosure provide an angiography image determination method and an angiography image determination device. The method includes: obtaining a plurality of first images of a body part injected with a contrast medium; obtaining a plurality of corresponding second images by performing a first image preprocessing operation on each first image; obtaining a pixel statistical characteristic of each second image; finding a candidate image based on the pixel statistical characteristic of each second image; and finding a reference image corresponding to the candidate image among the plurality of first images.

### CROSS-REFERENCE TO RELATED APPLICATION

This application claims the priority benefit of U.S. provisional application Ser. No. 63/291,461, filed on Dec. 20, 2021. The entirety of the above-mentioned patent application is hereby incorporated by reference herein and made a part of this specification.

### BACKGROUND

### Technical Field

The disclosure relates to an image determination mechanism, and particularly relates to an angiography image determination method and an angiography image determination device.

### Description of Related Art

In the related art, in order to identify whether a patient has stenotic blood vessels, it is necessary to inject a blood vessel contrast medium to the patient and take multiple angiography images of the body part injected with the blood vessel contrast medium. Then, the doctor needs to manually select the best angiography image with the best contrast among these angiography images, and find out the position corresponding to the stenosis of the blood vessel in the selected best angiography image before proceeding with the subsequent diagnosis.

However, it is not easy for the doctor or other personnel to select the best angiography image from the angiography images captured. Therefore, for those skilled in the art, how to design a mechanism for selecting angiography images that meet the requirements is an important issue.

### SUMMARY

Embodiments of the disclosure provide an angiography image determination method and an angiography image determination device.

An embodiment of the disclosure provides an angiography image determination method, adapted for an angiography image determination device. The angiography image determination method includes: obtaining a plurality of first images of a body part injected with a contrast medium; obtaining a plurality of second images corresponding to the first images by performing a first image preprocessing operation on each of the first images, in which each of the second images is a binarized image; obtaining a pixel statistical characteristic of each of the second images; finding at least one candidate image among the second images based on the pixel statistical characteristic of each of the second images; and finding at least one reference image corresponding to the at least one candidate image among the first images.

An embodiment of the disclosure provides an angiography image determination device, including a storage circuit and a processor. The storage circuit stores a program code. The processor is coupled to the storage circuit and accesses the program code to: obtain a plurality of first images of a body part injected with a contrast medium; obtain a plurality of second images corresponding to the first images by performing a first image preprocessing operation on each of the first images, in which each of the second images is a binarized image; obtain a pixel statistical characteristic of each of the second images; find at least one candidate image among the second images based on the pixel statistical characteristic of each of the second images; and find at least one reference image corresponding to the at least one candidate image among the first images.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram showing an angiography image determination device according to an embodiment of the disclosure.

FIG. 2 is a flowchart showing an angiography image determination method according to an embodiment of the disclosure.

FIG. 3 is a schematic diagram of obtaining first images and second images according to an embodiment of the disclosure.

FIG. 4 is a schematic diagram showing a change of a pixel statistical characteristic according to an embodiment of the disclosure.

FIG. 5 is a flowchart of a method of determining a stenosis ratio of a tubular object according to an embodiment of the disclosure.

FIG. 6 is a schematic diagram of identifying a first target area image according to an embodiment of the disclosure.

FIG. 7 is a schematic diagram of obtaining a second target area image according to an embodiment of the disclosure.

FIG. 8 is a schematic diagram of determining a stenotic position according to FIG. 7.

### DETAILED DESCRIPTION OF DISCLOSED EMBODIMENTS

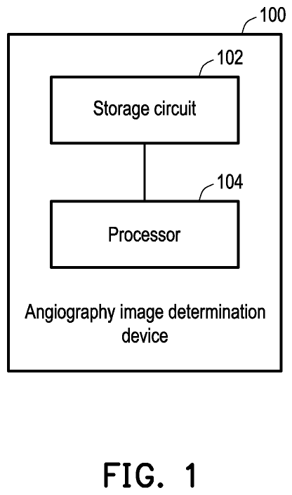

Please refer to FIG. 1, which is a schematic diagram of an angiography image determination device according to an embodiment of the disclosure. In different embodiments, the angiography image determination device 100 may be various smart devices, computer devices or any device with image processing/analysis functions, but not limited thereto.

In some embodiments, the angiography image determination device 100 may be used, for example, to operate a hospital information system (HIS) of a medical institution and may be used to provide medical staff with required information, but not limited thereto.

In FIG. 1, the angiography image determination device 100 includes a storage circuit 102 and a processor 104. The storage circuit 102 may be, for example, any type of fixed or removable random access memory (RAM), read-only memory (ROM), flash memory, hard disk, other similar devices or a combination of these devices, and may be used to record multiple program codes or modules.

The processor 104 is coupled to the storage circuit 102 and may be a general-purpose processor, a special-purpose processor, a traditional processor, a digital signal processor, multiple microprocessors, one or more microprocessors combined with digital signal processor cores, a controller, a microcontroller, an application specific integrated circuit (ASIC), a field programmable gate array (FPGA), any other type of integrated circuit, a state machine, an advanced RISC machine (ARM)-based processor, and the like.

In an embodiment of the disclosure, the processor 104 may access the modules and program codes recorded in the storage circuit 102 to realize the angiography image determination proposed by the disclosure, and the details are as follows.

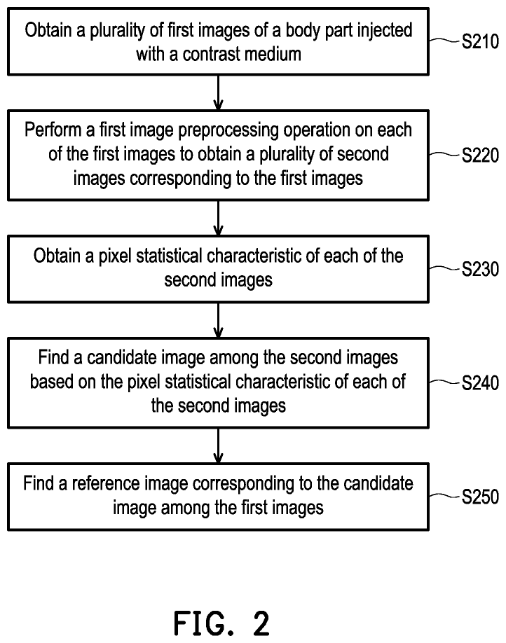

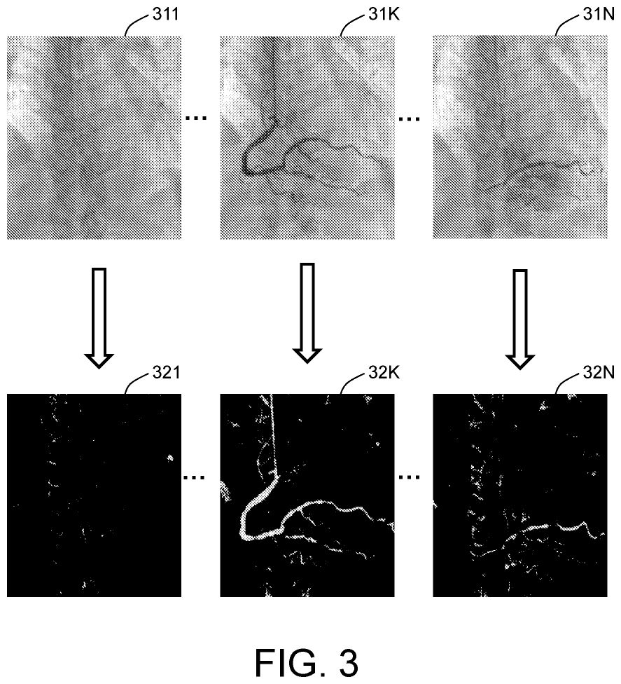

Please refer to FIG. 2, which is a flowchart of an angiography image determination method according to an embodiment of the disclosure. The method of this embodiment may be executed by the angiography image determination device 100 of FIG. 1, and the details of each step of FIG. 2 will be described hereinafter with reference to the components shown in FIG. 1. In addition, in order to make the concept of the disclosure easier to understand, the following will be described also with reference to FIG. 3, wherein FIG. 3 is a schematic diagram of obtaining first images and second images according to an embodiment of the disclosure.

First, in step S210, the processor 104 obtains a plurality of first images 311, . . . , 31K, . . . , 31N of a body part injected with a contrast medium.

In FIG. 3, the body part considered is, for example, a patient's coronary artery. The medical staff may inject a contrast medium into the patient and then continuously capture a plurality of angiography images of the area of the coronary artery with related instruments as the above-mentioned first images 311, . . . , 31K, . . . , 31N for subsequent processing/analysis of the processor 104, but the disclosure is not limited thereto.

In the scenario shown in FIG. 3, the contrast medium gradually darkens and then gradually brightens the blood vessels near the coronary artery over time. Therefore, in the related art, the doctor needs to select the best angiography image in which the contrast medium is most obvious (that is, the blood vessels are darkest) from the first images 311, . . . , 31K, . . . , 31N for subsequent diagnosis. However, as mentioned above, the process of picking the best angiography image is not easy. Thus, in an embodiment, the angiography image determination method proposed by the disclosure may be understood as an aid to the above selection, but not limited thereto. The details will be further described hereinafter.

After obtaining the first images 311, . . . , 31K, . . . , 31N, in step S220, the processor 104 performs a first image preprocessing operation on each of the first images 311, . . . , 31K, . . . , 31N to obtain a plurality of second images 321, . . . , 32K, . . . , 32N respectively corresponding to the first images 311, . . . , 31K, . . . , 31N.

In an embodiment, the first image preprocessing operation includes, for example, a binarization operation. For example, when the processor 104 performs the binarization operation on the first image 31K, the processor 104 may first determine the grayscale threshold corresponding to the first image 31K (for example, the grayscale average value of all the pixels in the first image 31K), and determine a pixel with a grayscale value lower than the grayscale threshold in the first image 31K as having the grayscale value of 255 (which corresponds to white, for example) and determine a pixel with a grayscale value higher than the grayscale threshold as having the grayscale value of 0 (which corresponds to black, for example). In short, the processor 104 may set all the pixels in the darker area (for example, the area corresponding to the blood vessels) in the first image 31K to the grayscale value of 255 and set all the pixels in the brighter area (for example, the area not corresponding to the blood vessels) in the first image 31K to the grayscale value of 0, but the disclosure is not limited thereto.

Further, the processor 104 may also perform the above-mentioned binarization operation on other first images. Accordingly, the obtained second images 321, . . . , 32K, . . . , 32N are all binarized images.

In addition, the first image preprocessing operation may further include at least one of a contrast enhancement operation and an erosion operation in image morphology. For example, when the processor 104 performs the contrast enhancement operation on the first image 311, the difference between the subject (for example, the blood vessels) and the background (for example, the area other than the blood vessels) in the first image 311 may be enhanced. In addition, when the processor 104 performs the erosion operation on the first image 311, for example, the processor 104 may correspondingly filter out the background noise in the first image 311 so as to achieve the effect of reducing the background noise.

In the scenario of FIG. 3, during the first image preprocessing, the processor 104 may sequentially perform the contrast enhancement operation, the binarization operation, and the erosion operation on each of the first images 311, . . . , 31K, . . . , 31N so as to obtain the second images 321, . . . , 32K, . . . , 32N (which are binarized images) respectively corresponding to the first images 311, . . . , 31K, . . . , 31N, but not limited thereto.

In step S230, the processor 104 obtains a pixel statistical characteristic of each of the second images 321, . . . , 32K, . . ., 32N. In an embodiment, the pixel statistical characteristic of each of the second images 321, . . . , 32K, . . . , 32N includes the sum of grayscale values of each of the second images 321, . . . , 32K, . . . , 32N. For example, the pixel statistical characteristic of the second image 321 is, for example, the sum of grayscale values of the pixels in the second image 321, the pixel statistical characteristic of the second image 32K is, for example, the sum of grayscale values of the pixels in the second image 32K, and the pixel statistical characteristic of the second image 32N is, for example, the sum of grayscale values of the pixels in the second image 32N, but not limited thereto.

In step S240, the processor 104 finds a candidate image among the second images based on the pixel statistical characteristic of each of the second images 321, . . . , 32K, . . . , 32N. In this embodiment, the candidate image may be understood as one or more second images that are more likely to correspond to the best (blood vessel) angiography image, but not limited thereto.

In the scenario of FIG. 3, since the pixels corresponding to the blood vessel area in each of the second images 321, . . . , 32K, . . . , 32N are, for example, white (that is, the grayscale value is 255), when the sum of grayscale values of a certain second image is high, it means that there are more white areas in the second image. That is, the blood vessels are more obvious.

Thus, the processor 104 may, for example, find a specific image with the highest pixel statistical characteristic (for example, the highest sum of grayscale values) among the second images 321, . . . , 32K, . . . , 32N as one of the candidate images. In the scenario of FIG. 3, assuming that the second image 32K has the highest sum of grayscale values, the processor 104 may, for example, determine the second image 32K as the specific image and take it as one of the candidate images.

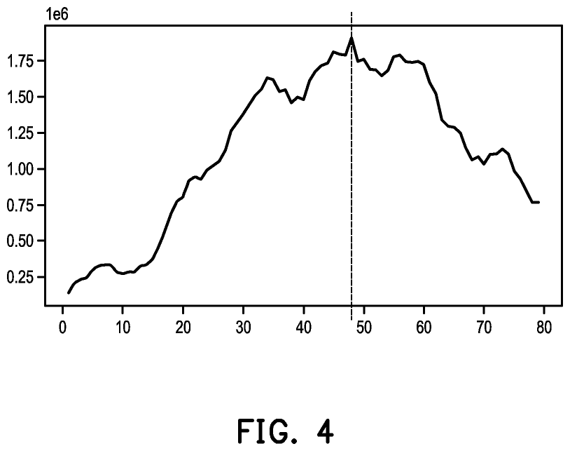

Please refer to FIG. 4, which is a schematic diagram showing a change of the pixel statistical characteristic according to an embodiment of the disclosure. In FIG. 4, the horizontal axis represents, for example, the index values of the second images 321, . . . , 32K, . . . , 32N, and the vertical axis represents, for example, the pixel statistical characteristic (for example, the sum of grayscale values) corresponding to each of the second images 321, . . . , 32K, . . . , 32N. In the scenario of FIG. 4, it can be seen that the highest pixel statistical characteristic roughly corresponds to the second image with the index value of 48. Accordingly, the processor 104 may, for example, take the second image ranked 48^{th} among the second images 321, . . . , 32K, . . . , 32N as the specific image, but not limited thereto.

In some embodiments, the processor 104 may also find at least one other image among the second images 321, . . . , 32K, . . . , 32N based on the specific image, wherein a time difference between each other image and the specific image is less than a time threshold. For example, assuming that the time threshold considered is 3 seconds, the processor 104 may, for example, take other second images within 3 seconds away from the specific image (for example, the second image 32K) as the other images, but not limited thereto. Thereafter, the processor 104 may determine that the above-mentioned other images also belong to the candidate images. That is, in addition to taking the specific image as the candidate image, the processor 104 may also take other images temporally close to the specific image as the candidate images, but not limited thereto.

Next, in step S250, the processor 104 finds a reference image corresponding to the candidate image among the first images 311, . . . , 31K, . . . , 31N. In an embodiment, assuming that the candidate image considered only includes the second image 32K, the processor 104 may, for example, take the first image 31K corresponding to the second image 32K as the reference image.

In other embodiments, assuming that the candidate images considered include other second images in addition to the second image 32K, the processor 104 may take the first image 31K corresponding to the second image 32K and other first images corresponding to the other second images as the reference images, but not limited thereto.

It can be known from the above that the embodiment of the disclosure may be used to find one of the images with the best contrast effect (for example, the first image 31K) among the first images 311, . . . , 31K, . . . , 31N. Accordingly, the efficiency of finding the best angiography image can be effectively improved, allowing the doctor to perform subsequent diagnosis based on the best angiography image.

In addition, in the embodiment of the disclosure, the angiography image with the best contrast effect may be provided together with other temporally close images as the reference images for the doctor's reference, allowing the doctor to subjectively select the required angiography image as the basis for subsequent diagnosis, but not limited thereto.

In other embodiments, the processor 104 may also find one or more reference images among the first images 311, . . . , 31K, . . . , 31N based on other methods.

In the first embodiment, the processor 104 may directly calculate the sum of grayscale values of each of the first images 311, . . . , 31K, . . . , 31N and determine the image with the lowest sum of grayscale values among the first images 311, . . . , 31K, . . . , 31N as the reference image.

In the second embodiment, the processor 104 may segment a specific area from the first images 311, . . . , 31K, . . . , 31N and then calculate the sum of grayscale values of the specific area in each of the first images 311, . . . , 31K, . . . , 31N. In the second embodiment, the processor 104 may segment the specific area in the first images 311, . . . , 31K, . . . , 31N by removing a (fixed) boundary area from each of the first images 311, . . . , 31K, . . . , 31N. For example, when the processor 104 segments the specific area in the first image 311, the processor 104 may obtain the specific area in the first image 311 by removing an area with a fixed width from four boundaries of the first image 311, but not limited thereto. Then, the processor 104 may calculate the sum of grayscale values of the specific area in the first image 311.

For other first images, the processor 104 may perform similar processing to obtain the specific area of each first image and the corresponding sum of grayscale values. Then, the processor 104 determines the image with the lowest sum of grayscale values among the first images 311, . . . , 31K, . . . , 31N as the reference image.

In the third embodiment, similarly, the processor 104 may segment a specific area from the first images 311, . . . , 31K, . . . , 31N and then calculate the sum of grayscale values of the specific area in each of the first images 311, . . . , 31K, . . . , 31N, but the processor 104 may segment the specific area from the first images 311, . . . , 31K, . . . , 31N, by a method different from the second embodiment.

Taking the first image 311 as an example, the processor 104 may search downward from the upper boundary of the first image 311 until the processor 104 finds a row with a significant change in grayscale value, and then take this row as the upper boundary of the specific area of the first image 311. Further, the processor 104 may search upward from the lower boundary of the first image 311 until the processor 104 finds a row with a significant change in grayscale value, and then take this row as the lower boundary of the specific area of the first image 311. Similarly, the processor 104 may search rightward and leftward from the left and right boundaries of the first image 311 until the processor 104 finds two columns with a significant change in grayscale value, and then take these two columns as the left and right boundaries of the specific area of the first image 311. Thereafter, the processor 104 may calculate the sum of grayscale values of the specific area in the first image 311.

In the third embodiment, the processor 104 may segment a specific area in other first images based on the above teaching, and calculate the corresponding sum of grayscale values. Then, the processor 104 determines the image corresponding to the lowest sum of grayscale values among the first images 311, . . . , 31K, . . . , 31N as the reference image, but not limited thereto.

In an embodiment, the processor 104 may perform further analysis/processing based on the obtained one or more reference images so as to obtain a further determination result. The details will be further described hereinafter.

For ease of understanding, one of the obtained one or more reference images (hereinafter referred to as the first reference image) will be described as an example, from which those skilled in the art should be able to understand the processing of other reference images performed by the processor 104.

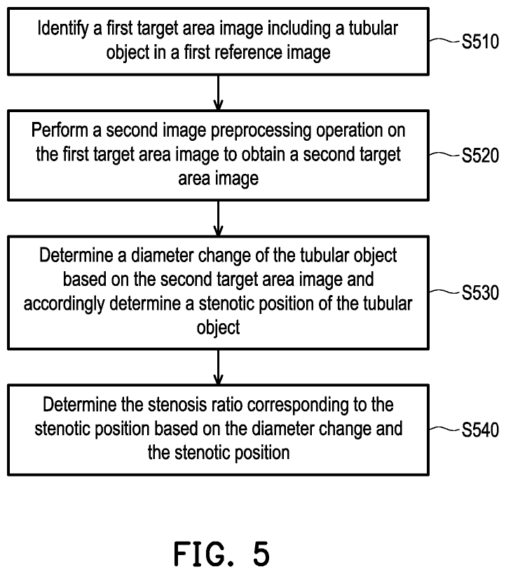

Please refer to FIG. 5, which is a flowchart of a method of determining a stenosis ratio of a tubular object according to an embodiment of the disclosure. The method of this embodiment may be executed by the angiography image determination device 100 shown in FIG.

1, and the details of each step in FIG. 5 will be described hereinafter with reference to the components shown in FIG. 1.

First, in step S510, the processor 104 identifies a first target area image including the tubular object in the first reference image. In the embodiment of the disclosure, the tubular object is, for example, a blood vessel segment with stenosis, but not limited thereto.

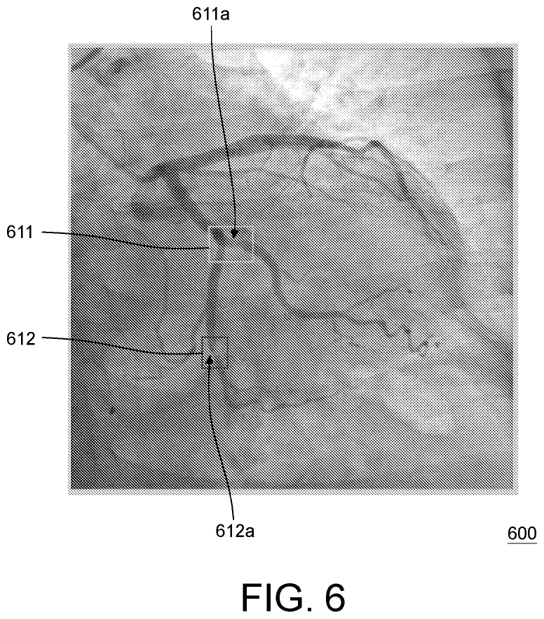

Please refer to FIG. 6, which is a schematic diagram of identifying the first target area image according to an embodiment of the disclosure. In FIG. 6, assuming that the first reference image 600 is one of the reference images obtained by the method of FIG. 2, the processor 104 may, for example, identify the first target area images 611 and 612 respectively including the tubular objects 611a and 612a in the first reference image 600. In this embodiment, the tubular objects 611a and 612a are, for example, blood vessel segments with stenosis, but not limited thereto.

In an embodiment, for example, the processor 104 may input the first reference image 600 into a pre-trained machine learning model, and the machine learning model may mark the first target area images 611 and 612 in the first reference image 600 accordingly.

In an embodiment, in order to enable the machine learning model to have the above-mentioned capability, during the training process of the machine learning model, the designer may feed specially designed training data into the machine learning model, so that the machine learning model can learn accordingly. For example, after obtaining an image marked as including an area of interest (for example, tubular object), the processor 104 may generate a corresponding feature vector and feed the feature vector into the machine learning model. Accordingly, the machine learning model can learn relevant features about the area of interest (for example, tubular object) from the feature vector. In this case, when the machine learning model receives an image corresponding to the feature vector in the future, the machine learning model can correspondingly determine that the image includes the area of interest (for example, tubular object), but not limited thereto.

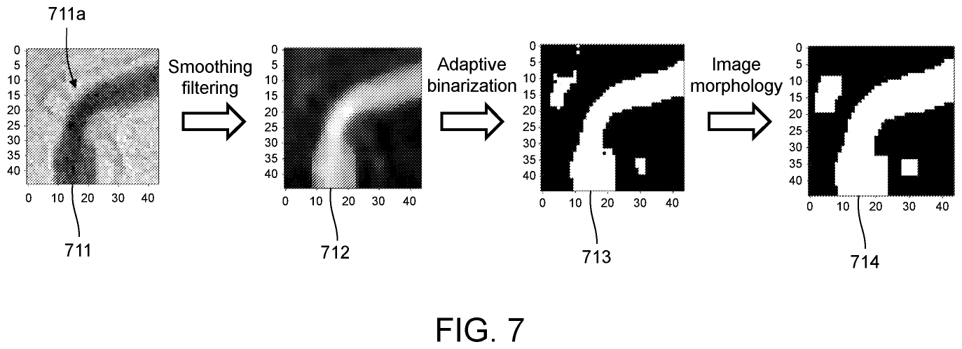

Afterward, in step S520, the processor 104 performs a second image preprocessing operation on the first target area image to obtain a second target area image. In order to make the concept of the disclosure easier to understand, the following will be described with reference to FIG. 7, wherein FIG. 7 is a schematic diagram of obtaining the second target area image according to an embodiment of the disclosure.

In FIG. 7, assuming that the first target area image 711 (which includes the tubular object 711a) is identified by the processor 104 in a first reference image. In this case, the processor 104 may perform the second image preprocessing operation on the first target area image 711.

In FIG. 7, while the processor 104 performs the second image preprocessing operation on the first target area image 711, for example, the processor 104 may sequentially perform image processing such as smoothing filtering, adaptive binarization, and image morphology on the first target area image 711 to obtain the second target area image 714, wherein the second target area image 714 is a binarized image.

In this embodiment, the processor 104 may, for example, perform image smoothing processing on the first target area image 711 by the above-mentioned smoothing filtering to obtain an image 712, thereby achieving the effect of reducing image noise.

Further, in the process of performing the above-mentioned adaptive binarization, the processor 104 may, for example, perform calculation for each pixel in the image 712 to determine the corresponding grayscale threshold, and then perform binarization on each pixel to obtain an image 713, thereby preventing other subsequent problems caused by uneven distribution of pixel grayscale.

Furthermore, in the process of processing the image 713 based on image morphology, the processor 104 may close (closing) the white area in the image 713 and then open (opening) the white area in the image 713 to obtain the second target area image 714, thereby achieving the effect of removing noise in blood vessels. In an embodiment, the above closing operation is, for example, to make the white area in the image 713 expand outward and then erode inward so as to filter out fine black spots in the blood vessels. In addition, the above opening operation is, for example, to erode inward the white area in the image 713 that has been opened, and then expand it outward so as to filter out fine white spots in the external background, but not limited thereto.

After obtaining the second target area image 714, in step S530, the processor 104 determines a diameter change of the tubular object 711a based on the second target area image 714 and accordingly determines a stenotic position of the tubular object 711a.

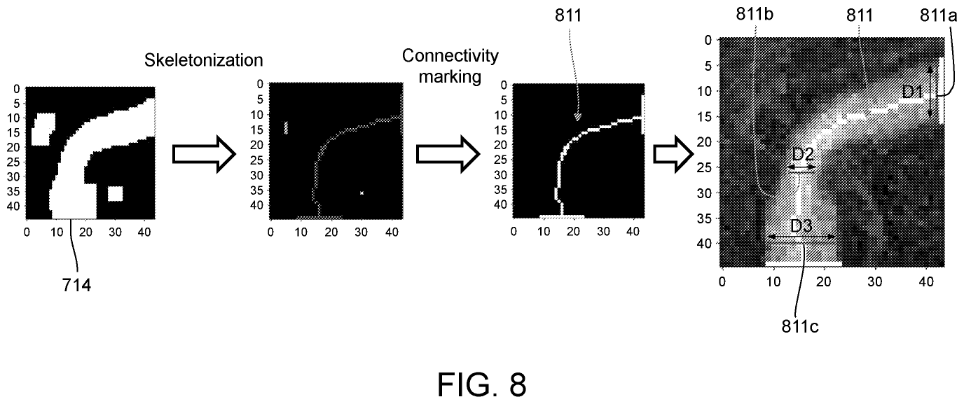

Please refer to FIG. 8, which is a schematic diagram of determining the stenotic position according to FIG. 7. In FIG. 8, for example, the processor 104 may determine a centerline 811 of the tubular object 711a in the second target area image 714 of FIG. 7, wherein the centerline 811 includes a plurality of candidate positions.

In an embodiment, the processor 104 may perform skeletonization (thinning) on each white area in the second target area image 714 and mark the largest connected area by a connectivity marking method so as to obtain the centerline 811 of the tubular object 711a, thereby preventing calculating the skeleton of other background noise.

In an embodiment, the processor 104 may perform the above skeletonization operation based on the medial_axis function in the image preprocessing function library named “scikit-image,” but not limited thereto.

Then, the processor 104 may determine the diameter of the tubular object 711a at each candidate position on the centerline 811 and accordingly determine the diameter change of the tubular object 711a.

In FIG. 8, assuming that the candidate positions 811a, 811b, and 811c are three of the candidate positions on the centerline 811, the processor 104 may accordingly determine the diameters D1, D2, and D3 of the candidate positions 811a, 811b, and 811c. The processor 104 may also determine the corresponding diameters for other candidate positions on the centerline 811.

Then, the processor 104 may, for example, determine the candidate position with the smallest diameter among the candidate positions on the centerline 811 as the stenotic position. For example, assuming that the diameter D2 is the smallest diameter, the processor 104 may determine that the candidate position 811b is the stenotic position, but not limited thereto.

After determining the stenotic position, in step S540, the processor 104 determines the stenosis ratio corresponding to the stenotic position based on the diameter change and the stenotic position.

In FIG. 8, the processor 104 may determine a first position and a second position on the centerline 811 on both sides of the stenotic position based on the diameter change. In this embodiment, it is assumed that the candidate positions 811a and 811c are respectively considered to be the first position and the second position, but not limited thereto. Then, the processor 104 may estimate an estimated diameter (hereinafter referred to as ED) corresponding to the stenotic position (for example, the candidate position 811b) based on the diameter D1 at the first position and the diameter D3 at the second position. In an embodiment, the processor 104 may, for example, estimate the estimated diameter ED between the diameters D1 and D3 by an interpolation method, but not limited thereto.

Next, the processor 104 may determine the stenosis ratio corresponding to the stenotic position based on the estimated diameter ED and the diameter D2 of the stenotic position (for example, the candidate position 811b). In an embodiment, the stenosis ratio may be expressed as “1−(D2/ED)×100%,” but not limited thereto.

In an embodiment, the first target area image 711 may be understood as an area where the blood vessels are blocked. Therefore, the processor 104 may also determine the length of the tubular object 711a based on the length of the centerline 811, that is, the length of the blood vessel that is blocked, but not limited thereto.

To sum up, the embodiments of the disclosure propose to find a reference image with the best angiography quality among multiple angiography images, thereby improving the efficiency of finding the best angiography image. Thus, the doctor can easily carry out the subsequent diagnosis based on the best angiography image. In addition, the embodiments of the disclosure further propose a method for determining the stenotic position and the corresponding stenosis ratio on the tubular object based on the reference image, which can serve as a reference for the doctor's subsequent diagnosis.

Although the disclosure has been described with reference to the embodiments above, they are not intended to limit the disclosure. Those skilled in the art may make changes and modifications without departing from the spirit and scope of the disclosure. Therefore, the scope of protection of the disclosure should be defined by the appended claims.

What is claimed is:

1. An angiography image determination method, adapted for an angiography image determination device, comprising:
obtaining a plurality of first images of a body part injected with a contrast medium;
obtaining a plurality of second images corresponding to the first images by performing a first image preprocessing operation on each of the first images, wherein each of the second images is a binarized image;
obtaining a pixel statistical characteristic of each of the second images;
finding at least one candidate image among the second images based on the pixel statistical characteristic of each of the second images; and
finding at least one reference image corresponding to the at least one candidate image among the first images.

2. The angiography image determination method according to claim 1, wherein each of the first images is an angiography image.

3. The angiography image determination method according to claim 1, wherein the first image preprocessing operation at least comprises a binarization operation.

4. The angiography image determination method according to claim 3, wherein the first image preprocessing operation further comprises at least one of a contrast enhancement operation and an erosion operation.

5. The angiography image determination method according to claim 1, wherein the pixel statistical characteristic of each of the second images comprises a sum of grayscale values of each of the second images.

6. The angiography image determination method according to claim 1, wherein finding the at least one candidate image among the second images based on the pixel statistical characteristic of each of the second images comprises:
finding a specific image with the highest pixel statistical characteristic among the second images as one of the at least one candidate image.

7. The angiography image determination method according to claim 6, wherein the first images are obtained through continuous imaging, and finding the at least one candidate image among the second images based on the pixel statistical characteristic of each of the second images comprises:
finding at least one other image among the second images based on the specific image, wherein a time difference between each of the at least one other image and the specific image is less than a time threshold; and
determining that the at least one other image belongs to the at least one candidate image.

8. The angiography image determination method according to claim 1, wherein the at least one reference image comprises a first reference image, and the angiography image determination method further comprises:
identifying a first target area image comprising a tubular object in the first reference image;
obtaining a second target area image by performing a second image preprocessing operation on the first target area image, wherein the second target area image is a binarized image;
determining a diameter change of the tubular object based on the second target area image, and accordingly determining a stenotic position of the tubular object; and
determining a stenosis ratio corresponding to the stenotic position based on the diameter change and the stenotic position.

9. The angiography image determination method according to claim 8, wherein determining the diameter change of the tubular object based on the second target area image comprises:
determining a centerline of the tubular object in the second target area image, wherein the centerline comprises a plurality of candidate positions; and
determining a diameter of the tubular object at each of the candidate positions, and accordingly determining the diameter change of the tubular object.

10. The angiography image determination method according to claim 9, wherein the stenotic position corresponds to one of the candidate positions which has a smallest diameter.

11. The angiography image determination method according to claim 9, wherein determining the stenosis ratio corresponding to the stenotic position based on the diameter change and the stenotic position comprises:
determining a first position and a second position on the centerline on both sides of the stenotic position based on the diameter change;
estimating an estimated diameter corresponding to the stenotic position based on a diameter at the first position and a diameter at the second position; and
determining the stenosis ratio corresponding to the stenotic position based on the estimated diameter and a diameter at the stenotic position.

12. The angiography image determination method according to claim 9, further comprising:
determining a length of the tubular object based on a length of the centerline.

13. An angiography image determination device, comprising:
a storage circuit storing a program code; and
a processor coupled to the storage circuit and accessing the program code to:
obtain a plurality of first images of a body part injected with a contrast medium;
obtain a plurality of second images corresponding to the first images by performing a first image preprocessing operation on each of the first images, wherein each of the second images is a binarized image;
obtain a pixel statistical characteristic of each of the second images;
find at least one candidate image among the second images based on the pixel statistical characteristic of each of the second images; and
find at least one reference image corresponding to the at least one candidate image among the first images.
